(19) United States
(12) Patent Application Publication
(10) Pub. No.: US 2006/0217999 A1
(43) Pub. Date: Sep. 28, 2006

(54) Document management system

(75) Inventors: Rene F.A. Collard, Gennep (NL); Robert Weyers, Helmond (NL); Manuel Bilderbeek, Nijmegen (NL); Matthijs F. Mullender, Venlo (NL); Roeland K. Brand, Helmond (NL); Teun K.J. Willems, Geldrop (NL); Igor L.H. Martin, Eindhoven (NL)

Correspondence Address: BIRCH STEWART KOLASCH & BIRCH, PO BOX 747, FALLS CHURCH, VA, 22040-0747, US

(73) Assignee: OCE-TECHNOLOGIES B.V., Venlo (NL)

(21) Appl. No.: 11/374,018

(22) Filed: Mar. 14, 2006

(30) Foreign Application Priority Data
Mar. 15, 2005 (EP) 05102042.8

(51) Int. Cl. G06Q 99/00

(52) U.S. Cl. 705/1

(57) ABSTRACT

A method and a system for managing a plurality of administrative files of various different categories stored in a file storage facility. Each of the files allow for amending, such as by putting therein one or more documents of various different nature. The method includes assigning a pre-structured format to each applicable file category. Each pre-structured format accommodates a set of document entries. Each of the document entries is distinguished according to a predetermined nature of the document entry. The method also includes assigning a content form to each file for listing a set of document entries in a list, and upon amending a file on account of a particular document, indicating in the list the amending by at least a presence indicator.

### CROSS-REFERENCE TO RELATED APPLICATIONS

This nonprovisional application claims priority under 35 U.S.C. §119(a) on Patent Application No. 05102042.8, filed in Europe on Mar. 15, 2005, the entirety of which is incorporated herein by reference.

### BACKGROUND OF THE INVENTION

1. Field of the Invention

The present invention generally relates to document management systems. In particular, the present invention relates to a method for managing a plurality of administrative files or dossiers of various different categories. The method includes storing the files in a file storage facility (84) and facilitating amending the stored files, such as by putting therein one or more documents of various different natures. The present invention also relates to a computerized administrative file handling system that is arranged for implementing the method of the present invention.

2. Description of Background Art

A prime, but not limiting, example of a method as recited above is local government, such as when it is involved in the issuing of a broad variety of licenses. It has been found that in such environments, the number of different documents in a file is often limited. Usually, each possible document in the file has been specified beforehand. However, for a particular type of file the instants and sequence of entering the documents is quite variable and often unpredictable. Also, for each type of file there may be many individual instances that do not have to be processed in a fixed sequence. Furthermore, there are often as many as several hundreds of different types of files, which each need a different set of documents. In addition, for a particular type of file, all specified documents are not always necessary. For example, when a particular document implies a rejection, the collecting of further documents would be superfluous. Moreover, often a particular file should be open to being processed by various different persons or departments.

In the background art, the importance of correct management has been recognized. However, the necessity for steady improvement is pertinent, such as being driven by faster procedures, tight timetables, the legal obligation to allow public inspection of various files, and the general requirement for optimum quality.

For instance, U.S. Patent Application Publication No. 2004/0179224 A1 to Kidokoro discloses an image processing apparatus and method that is suitable for inputting and outputting documents in a document repository. However, the Kidokoro reference does not relate to the managing of various different files and including a multiplicity of documents an as overall target.

Also, several elaborated digital document management systems with built-in workflows for complicated procedures have been proposed. While providing a great versatility in application, such systems often require a high degree of training and adaptation of the clerks, who have often been working with hard copy files for many years.

### SUMMARY OF THE INVENTION

In consequence, amongst other things, it is an object of the present invention to carry out the above described managing in a simple and fast manner, while accommodating a wide variety of file categories, complexities, processing periods and other parameters. It is also an object of the present invention to provide a method of managing dossiers related to administrative procedures that as much as possible fits to the experience of the people handling it, and does not impose additional system-related working rules unless absolutely necessary.

Moreover, the avoidance of errors should have a high priority.

According to one aspect of the present invention, a method for managing a plurality of administrative files of various different categories comprises the steps of:

Storing the files in a file storage facility;

Facilitating amending of the stored files by putting therein one or more documents of various different nature;

Assigning a pre-structured format to each of the file categories, wherein each format accommodates a set of document entries, each of the set of document entries being distinguished according to a predetermined nature of the document entry;

assigning a content form to each of the file categories for listing a respective set of document entries in a list; and

upon amending a respective file category on account of a particular document, indicating the amending in said list by at least a presence indicator.

With the above method according to an embodiment of the present invention, a present state of processing is rendered immediately visible by representing a file by its content form that represents both actual and intended contents thereof. The content form can also be referred to as a “front page” or “header page.” When a document is added or, as the case may be, suppressed, the corresponding entry on the front page is amended. An additional advantage hereof is, that this way of presenting the contents of the file closely resembles a conventional hard copy file, wherein the file contents can also readily be inspected. And, just like in a hard copy file, documents may in principle be entered at will.

Advantageously, the amending is furthermore indicated in the list by a presentation of any of an amending instant and an amending person or department. This allows the state of the document to be immediately ascertained, and possibly, to see what must be done next with the file. The term “department” is herein intended to cover any applicable group of persons, authority, firm or other legal or factual organization.

In an embodiment of the present invention, the method includes allowing transferring of a file from one entity handling it, to an other entity. In this connection, an entity is meant to be a person or a department.

Such transfer may be effected through communicating one or more applicable links pertaining to that file as stored in the file storage facility, without necessitating transfer of the complete file. Such communicating would advantageously be in the form of an e-mail including said link.

Transferring a file to another entity may be done for adding information or the like, without also transferring the ownership, that is, the responsibility over the file, but it may also be done with transfer of ownership, when the receiving party must indeed take over the responsibility of the further administrative procedure. In the latter case, the actual transfer may for instance be done in the same way as in the former case, that is, by e-mailing a link to the file.

In a further embodiment, entering of a document into a file is effected through either scanning and digitizing, or direct entering of a digital document. The method further includes comparing a current list of entered documents in said file with a list amended by an entity handling the file in association with entering a document, and automatically updating the file content accordingly.

Thus, through comparing successive versions of the front page, the system embodying the present invention may determine which documents are added, amended, or suppressed. The file can then be updated to reflect the new situation.

The present invention also relates to a computerized administrative file handling system that is arranged for implementing the method of the present invention. In particular, the system comprises:

at least one user workstation; and

a file managing module, said file managing module including a file storage facility for managing of a plurality of administrative files of various different categories stored in the file storage facility, said file managing module being capable of facilitating amending of the stored files by putting therein one or more documents of various different nature through the at least one user workstation,

wherein the file managing module is further capable of:

assigning a pre-structured format to each of the file categories, wherein each format accommodates a set of document entries, each of the set of document entries being distinguished according to a predetermined nature of the document entry;

assigning a content form to each of the file categories for listing a respective set of document entries in a list;

displaying a respective content form on a workstation screen;

allowing amendments to be made to a file through manipulation of the respective content form; and

upon an amendment being made to a file on account of a particular document, indicating the amending in said list by at least a presence indicator.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a technical set-up of a Documentary Dossier System according to an embodiment of the present invention;

FIG. 2 is a typical example of a work flow in a document management procedure according to an embodiment of the present invention;

FIG. 3 is a scheme of a file amending procedure; and

FIG. 4 is an exemplary Document Header Page for use in an embodiment of the present invention with all textuals inserted.

### DETAILED DESCRIPTION OF THE PREFERRED EMBODIMENTS

The present invention will now be described with reference to the accompanying drawings, wherein the same or similar elements will be identified with the same reference numeral.

The present invention is primarily intended for administrative organisations, such as local government, in which administrative procedures such as the issuing of licenses are executed. Such procedures are generally started by reception of a request or other communication from an external person or entity such as a customer. The actual administrative procedure that follows is often characterized by collecting information and storing the same in a dossier or file.

When all required information has been collected (included in the file), a decision is taken and/or a response is given to the customer, whereafter the file is closed and archived. In many procedures that are contemplated by the present invention, the file structure is fixed, i.e. it is known beforehand which documents must be entered or at least may be entered in the file before the case can be closed.

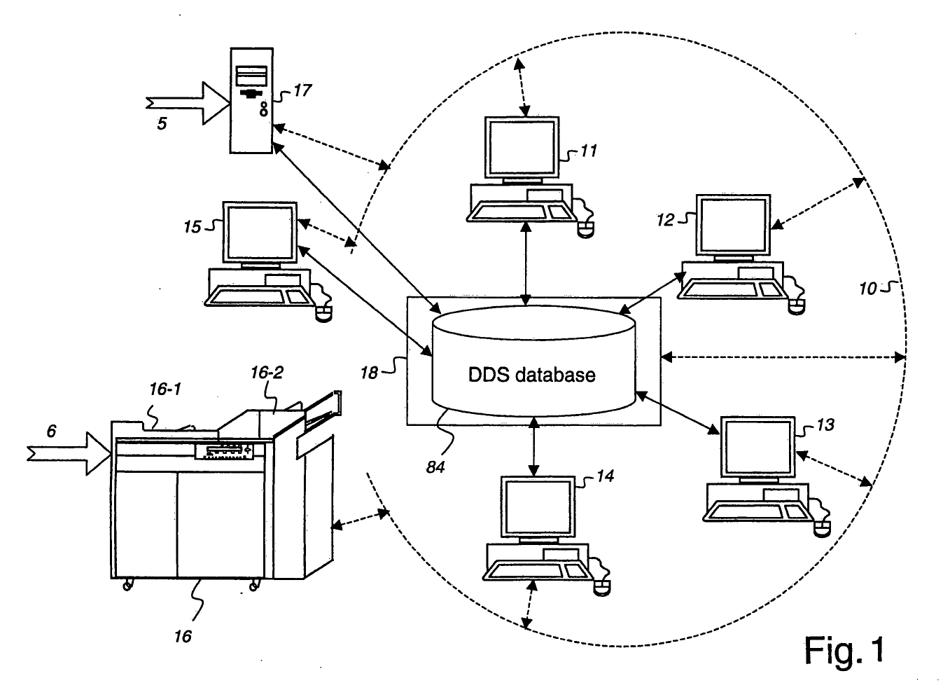

FIG. 1 illustrates the technical set-up of a so-called Documentary Dossier System (DDS) implementing the present invention that is particularly suitable for supporting the above-described administrative procedures. User workstations 11, 12 13, 14 and 15, a server 17 for external connections, a multi-functional device 16 including a scanner section 16-1 and a printer section 16-2, a file manager 18 including a database 84 and a digital network 10 connecting them (shown by broken lines) are illustrated in FIG. 1. The workstations and the server can store and retrieve data files in the database 84. File transfer is symbolized by non-broken arrows. The file manager 18 also includes a user interface engine (not shown), preferably in the form of a web server for communication with web browsers installed in the respective workstations. The database stores all document files that are needed or generated in the course of the various administrative procedures. The reception of the request or other communication from a customer is symbolized by arrows 5 (digital reception) and 6 (reception by mail, which is scanned by the mailroom personnel using scanner 16-1 to convert it to digital form).

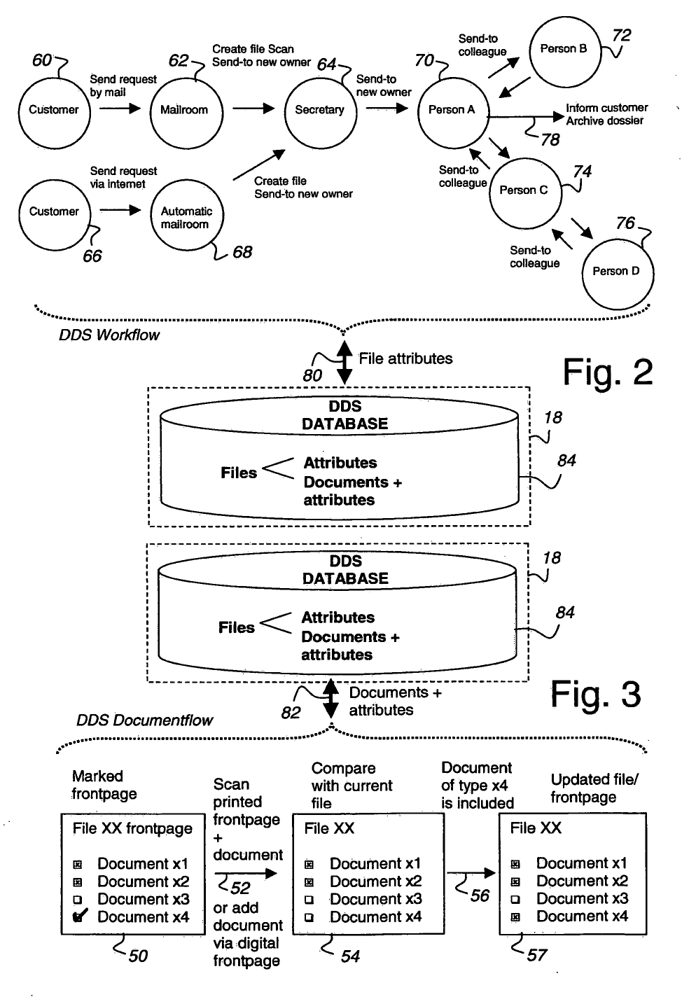

FIG. 2 is typical example of a work flow in a document management procedure and a scheme of a file updating procedure according to the present invention, also referred to as the DDS Workflow. Specifically, a customer 60 sends a request by mail, which is received in mail-room 62. A dedicated file is then created in the database 84 by the file manager 18. The request document proper is scanned and stored in the file. An e-mail including a link to the file is then sent to a new owner, for example a secretary 64. File particulars, such as the name and address of the customer, the kind of request and possibly some more detailed information, can be automatically detected in the scanning step by OCR (optical character recognition) and other appropriate software applications. The file particulars can be added to the new file, preferably after a check by an operator. Alternatively, the mail operator can visually inspect the request and add the file particulars.

Likewise, a customer 66 can send a request by the Internet, such as by e-mail. The request is received in an automatic mailroom 68 that is implemented in a server 17 (see FIG. 1). A file is created using the file manager 18 and the request is stored therein, possibly together with manually or automatically detected file particulars. An e-mail including a link to the file is then sent to the new owner, for example the secretary 64. Obviously, in this case the request proper needs no scanning. It is noted here that the file as created is pre-structured, i.e. it already contains entries for all documents that must be entered before the case can be finished, as is explained above.

Secretary 64 selects a new owner for attending to the request, for example a clerk 70, by sending an e-mail including a link to the file. Alternatively, the request may only be entered in the database without creating a file upon reception, and the secretary 64 may create the file.

Clerk 70 can signal colleagues 72, 74, 76 by exchanging e-mails to execute certain tasks with regard to the file in question. “Done” reciprocating e-mails signal various progress in the handling of the file. Ultimately, clerk 70 can inform the customer and/or order archiving (78) the file in question.

The above DDS Workflow is related to the file stored in the DDS Database 84 and managed by the file manager 18 by the various file attributes stored therein, as is symbolized by arrow 80. The database 84 stores the files, that as indicated contain Attributes proper. Furthermore, the associated documents are also provided with their particular attributes. Examples of the latter are further explained with reference to FIG. 3, where they are shown connected through arrow 82 with the DDS Document flow.

FIG. 3 illustrates an exemplary scheme of a file updating procedure. A basic element of the procedure is a file front page that includes the actual and intended contents of the file in a human-readable form. The front page plays a central role in the file handling for the clerks involved.

A marked front page (50) of file XX is shown at the left in FIG. 3. As shown, file XX is pre-structured to contain four documents x1, x2, x3 and x4, of which two (x1, x2) are already included (shown by a cross in the associated check box). One (x4) has been targeted for entering (shown by a check mark drawn by the operator in the associated tick box), and one (x3) is still void.

The front page (50) and the document to be inserted are then scanned (52) and the scanned image of the front page is automatically compared with the current version of the file (54) in the database. For simplicity, the scanning proper has not been indicated in FIG. 3. The system automatically recognizes the discrepancy of the signalization in respect of Document x4 and accordingly, the file manager 18 adds the scanned document to the file in question (56) under the relevant name and stores the document file itself in the database 84. If the front page were recalled, it would have a correspondingly amended form, as shown at the right-hand side of FIG. 3 (57).

Alternatively, a document that is in digital form already, e.g. an edited document file, can be directly entered into the file using a digital user interface as will be described hereinafter.

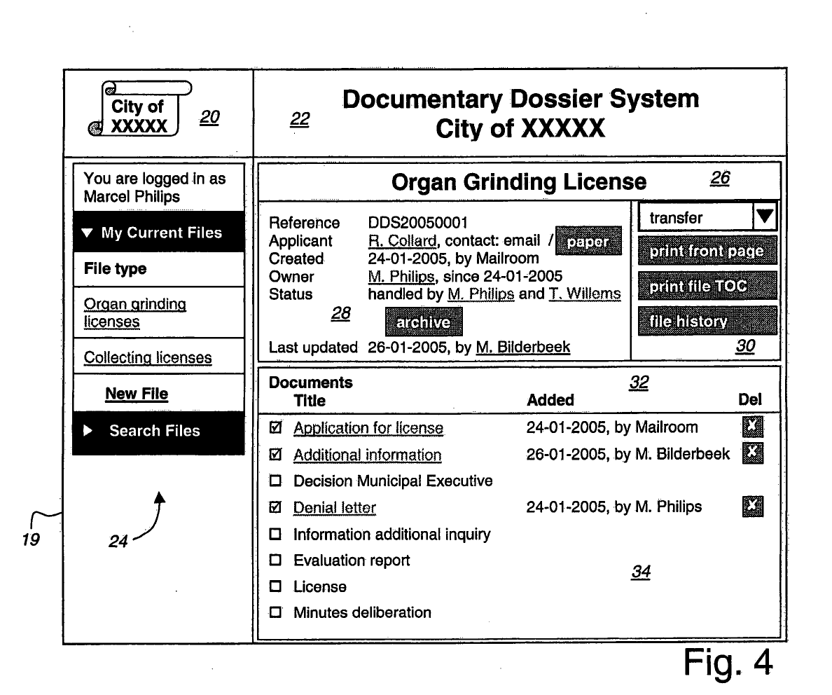

FIG. 4 illustrates an exemplary user interface display image by which the respective workstations 11, 12, 13, 14, 15 can communicate with the file manager 18 as shown in FIG. 1. The display image includes a Document Header Page 19 generated by the web server in the database and displayed on the screens of the workstations. First, the reference numerals will be identified for a quick discussion of the document. The top field 20 sets forth the municipal symbol. Field 22 indicates the user administration, for example the City of XXXXX. Field 24 indicates the current user, a list of currently “open” files, a file creation button, and a file search button. Field 26 identifies the class of the currently opened file (“Organ grinding License”). Field 28 further specifies the file as will be discussed more in detail hereinafter. Field 30 contains a drop-down menu box for transferring the file to a new owner, for transmitting it to a colleague or for returning it to the sender. Furthermore, field 30 contains various control buttons, such as for printing an (updated) front page, for printing a file overview (Table of Contents (TOC)) and for displaying the file history.

When a file TOC is ordered, a page is printed showing the first pages of the available documents as thumbnails. Each thumbnail has a check box added to it and the user may check one or more of the check boxes and feed the page into a scanner. The system then automatically determines which ones of the boxes was checked and prints the complete associated documents.

Field 32 is a header for the document identifiers therebelow. Field 34 contains a pre-programmed list of particular documents that can be relevant to the file in question and which therefore may be present in the file. Such lists are predefined for each respective type of file and automatically appear upon creation of a new file. The series of fields is generally limited, and each field relates to a particular document. Nevertheless, in certain cases a supplementary field may be present, without any particular assignment given thereto for documents that are unforeseen.

The various textuals associated to the example page will now be described. In particular, field 24 has on successive lines the name of the actual user (“Marcel Philips”), a header indicating all open files (“My Current Files”) (the files are actually shown as the available display can accommodate, but other open files may be hidden from view while being immediately accessible), a header indicating by “File type”, the type(s) of various file(s). Each file type can be clicked on and then opens to show a list of current files of that type, i.e. in the exemplary case of “Organ grinding licenses” there may be accommodated several applications of such a license by different customers/applicants. Clicking on one such file results in display of the details of that file in the window formed by the fields 26 through 34.

Further lines in the field 24 are a file creation (“New File”) button, and a file search button.

Field 28 has on successive lines the file identifier (DDS20050001), the customer (R. Collard) who has applied for an organ grinding license and associated communication signalization, such as e-mail or paper. Clicking on the “paper” button automatically opens an editor for drafting a letter to that customer, with all particulars filled in already. Likewise, clicking on the name of the customer automatically opens the e-mail client of the workstation for sending an e-mail to the customer. The next line indicates the data of creating the document, and its original author (“Mailroom”). The next line indicates the current owner (M. Philips), the date of ownership, and a button for archiving the file. Activating the latter button will close the file in question; it may be opened again via field 24, last line. The last line of field 28 indicates the persons actually busy on the file (M. Philips, T. Willems). “Busy” may indicate that the file has been sent to those persons for them to add a document or take some other action. A file is sent in the form of an e-mail specifying a link to the file in the database. The sender can use the e-mail to add some specific remarks relevant for the case.

Field 32 is a header for the document identifiers therebelow and indicates the various document specifiers, in this case title and entering particulars. The field 34 contains the list of documents. The first column is a presence indicator in the form of a check box. The second column indicates the name or character of the document, and the third column indicates the date of entering the document and the author of such entering, respectively, while the last one is a delete button. Generally, the document title in field 34 is “clickable,” such that when it is clicked, the document opens on the display screen of the workstation.

The first line of the list represents the basic document (here, the actual application for the license). Further lines identify the various other required documents and signal, by the presence indicator, whether the document in question has been entered or not.

It should be clear from the above that documents can be added to a DDS (Documentary Dossier System) in various different sequences and by any person that has the proper clearing to access the DDS. Thus the work flow is not constant, and can even be assigned to a varying set of persons and/or departments.

A typical example is the following. Person A is the actual owner and adds documents x1 and x3 to the file. The file status is then “handling by A”. Next, persons B and C should add documents x2 and x4, respectively. Person A may now select “send to colleague” and thereby, send an e-mail with a link to the digital front page to alert person B. The file alert will be accepted when the receiver clicks on the link in question. In the DDS, the file status is now changed to “handling by A and B”. Still, the DDS knows that A had sent this link. When person B has completed the job, he can select “mail back to sender”, and in response the DDS sends an e-mail with the file link to person A. When A accepts this mail by clicking on the link, the status of the file is reverted to “handling by A”. Person A can now send the file to person C for adding document x4. Alternatively, person B can first send the file to C for adding x4, before returning the file to A. Accordingly, the file status will then change into “handling by A and C”. When C has added document x4, he simply returns the file to sender, i.e., B, and B can return it to A.

For reasons of simplicity and transparency, circular workflows that contain a chain of three or more stages are not allowed, although it is not principally impossible to implement circular chains. This inhibiting is realized through comparing the e-mail addressee with the persons in “handling by”. Alternatively to “send to/back to colleague”, the file ownership can be similarly changed by sending an e-mail with the file link. Although the above “free” workflow support is fully independent from the actual order wherein the documents are added to the DDS, and also independent from the specific persons that are involved in the DDS, the DDS can in effect be used as a self-learning workflow system by registering and accumulating the actual work-flows. This workflow information can then in turn be used to support the workflow of the persons using the DDS, such as in various procedures prompting the associated correct addressees. Another usage of the workflow information is to provide management information for effecting workflow control.

Generally, the document and workflow management system according to the present invention applies for situations wherein the major part of actions is the accumulating of information according to fixed prescriptions and then deciding as based on the available information. This means that in principle, only prescribed documents should be entered into the file. It is not always necessary that all documents be in the file. For example, an appeal against a negative decision will not always be lodged by a customer.

The documents can be entered into the file by either scanning and digitizing or by directly entering digital documents into a website-like structure, of which the front page operates as an automatic table-of-contents.

In document entry through scanning, the steps are:

(1). printing the front page by clicking the appropriate button in the field 30 of the user interface (FIG. 4);

(2). manually amending the printed front page by placing a sign in the appropriate tick box; and

(3). scanning in succession the amended front page and the document to be entered.

The system recognizes the scanned front page, e.g. from a bar code that was automatically added to the front page in the printing stage, compares it with the front page stored in the database and decides therefrom what document is to be added and actually adds the document to the database, possibly after pre-processing such as OCR (optical character recognition).

If a digital document is to be added, the user can simply click the check box preceding the document name in field 34 of the user interface, whereupon a browse box is opened in the same line of field 34. The user can now specify the intended document in the browse box and upload it to the system.

Further processing can be effected by e-mailing only appropriate links to the files, not the entire file. The DDS records the actual workflow pertaining to each file. The actual workflow can be inspected by clicking the appropriate button in field 30 of the user interface.

An (external) customer will also have access to the DDS to check (but not amend) the status of the customer's file. When a pertinent request is sent digitally, an automatic mailroom will recognize the request, create a new file, and send an e-mail with a link to the secretary of the relevant department. The customer can amend preferences with regard to communication media (paper/e-mail/phone) in the DDS. In fact, the “free” work flow is independent of the actual documents in the file. Part of the work flow can in fact still be paper-based without relying on e-mail. The important aspect is that the DDS always knows who has added a document to the DDS. When done digitally, this is the one who logged on. When done by scanning the marked front page plus the document, the DDS will recognize the name of the person who printed the front page, such as by being represented in a bar code together with the file ID. When a file has been completed, the owner will inform the relevant customer, and change the file status to “archived”.

Now, the present invention has hereinabove been disclosed with reference to preferred embodiments thereof. Persons skilled in the art will recognize that numerous modifications and changes may be made thereto without exceeding the scope of the appended claims. For example, instead of a two-level file, the structure can be extended by allowing certain documents to be joined into a sub-file, so that effectively, a tree structure is feasible. Furthermore, cross-referencing among documents can be rendered feasible in the document entries (36, 38). Also, interaction between parties operating on a particular file can be effected by communication protocols that are becoming commonplace, for example “instant messaging.”

Furthermore, the present invention has been elucidated with reference to a working environment formed by local government, but that is not to be construed as limiting the application. Any organisation handling pre-structured files would benefit from the present invention. In consequence, the embodiments discussed should be considered as being illustrative, and no restriction should be construed from those embodiments, other than as have been recited in the claims.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for managing a plurality of administrative files of various different categories, comprising the steps of:
storing the files in a file storage facility;
facilitating amending of the stored files by putting therein one or more documents of various different nature;
assigning a pre-structured format to each of the file categories, wherein each format accommodates a set of document entries, each of the set of document entries being distinguished according to a predetermined nature of the document entry;
assigning a content form to each of the file categories for listing a respective set of document entries in a list; and
upon amending a respective file category on account of a particular document, indicating the amending in said list by at least a presence indicator.

2. The method as claimed in claim 1, wherein the amending is further indicated in the list by a presentation of any one of an amending instant and an amending person or department.

3. The method as claimed in claim 1, wherein the pre-structured format further contains file metadata including a file identifier and any one of a creation instant, a creating entity, an owner entity and a currently handling entity, and an entity is a person or a department.

4. The method as claimed in claim 1, further comprising the step of allowing transferring of a file from one entity to another entity.

5. The method as claimed in claim 4, wherein the transfer of a particular file is effected through communicating one or more applicable links pertaining to that file as stored in the file storage facility, without necessitating transfer of the complete file.

6. The method as claimed in claim 4, wherein circular transfers containing a chain of three or more entities are inhibited.

7. The method as claimed in claim 4, wherein a change of ownership between entities is effected by sending an e-mail including an associated file link between the entities.

8. The method as claimed in claim 1, wherein the amending of a file is limited to a pre-selected set of persons or departments, but file inspection is open to further pre-selected persons or departments outside said pre-selected set.

9. The method as claimed in claim 1, wherein entering of a document into a file category is effected through either scanning and digitizing, or direct entering of a digital document, the method further including the steps of:
comparing a current list of entered documents in said file category with a list amended by an entity handling the file in association with entering a document; and
automatically updating the file content accordingly.

10. The method as claimed in claim 1, wherein entry, by a handling entity, of a document into a particular file permanently tags an identifier of said handling entity to said document.

11. The method as claimed in claim 1, wherein, upon completion of a file, said method further comprising the step of signalling a customer accordingly and/or archiving the file in question, while suppressing further appearance of the file in a list of current files.

12. The method as claimed in claim 1, further comprising the steps of automatically analyzing various particulars of actual workflows involving respective file types and automatically proposing handling steps based on said analysis.

13. A computerized administrative file handling system comprising:
at least one user workstation; and
a file managing module, said file managing module including a file storage facility for managing of a plurality of administrative files of various different categories stored in the file storage facility, said file managing module being capable of facilitating amending of the stored files by putting therein one or more documents of various different nature through the at least one user workstation,
wherein the file managing module is further capable of:
assigning a pre-structured format to each of the file categories, wherein each format accommodates a set of document entries, each of the set of document entries being distinguished according to a predetermined nature of the document entry;
assigning a content form to each of the file categories for listing a respective set of document entries in a list;
displaying a respective content form on a workstation screen;
allowing amendments to be made to a file through manipulation of the respective content form; and
upon an amendment being made to a file on account of a particular document, indicating the amending in said list by at least a presence indicator.

14. The system according to claim 13, wherein said file managing module is capable of maintaining metadata for each file category, the metadata including a file identifier and any one of a creation instant, a creating entity, an owner entity and a currently handling entity, and an entity is a person or department.

15. The system according to claim 14, wherein said file managing module is capable of allowing transferring of ownership and/or handling of a file from one entity to another entity.

16. The system according to claim 13, further comprising a scanner for scanning and digitizing documents, wherein said file managing module is capable of comparing a scanned list document with a current list corresponding to said content form, the scanned list having at least one marking applied to it, and automatically updating a file content with an equally scanned document accordingly.

17. The system according to claim 13, wherein said file managing module is capable of detecting manipulation of the content form displayed on a workstation screen and allowing importing or deleting of a file in accordance with a detected manipulation.

18. The system according to claim 13, wherein said file managing module is capable of automatically analyzing various particulars of actual workflows involving respective file types and automatically proposing handling steps based on the analysis.
